(19) United States
(12) Patent Application Publication
(10) Pub. No.: US 2017/0104271 A1
(43) Pub. Date: Apr. 13, 2017

(54) COMPACT MULTI-FREQUENCY HORN ANTENNA, RADIATING FEED AND ANTENNA COMPRISING SUCH A HORN ANTENNA

(71) Applicant: THALES, Courbevoie (FR)

(72) Inventor: Paddy PEROTTINO, TOURNEFEUILLE (FR)

(21) Appl. No.: 15/289,346

(22) Filed: Oct. 10, 2016

(30) Foreign Application Priority Data
Oct. 9, 2015 (FR) 1502126

(51) Int. Cl. H01Q 5/55; H01Q 1/48; H01Q 15/14

(52) U.S. Cl. CPC H01Q 5/55; H01Q 15/14; H01Q 1/48

(57) ABSTRACT

A horn antenna, able to propagate signals in a spectrum of frequencies B1, . . . , Bi, . . . , BN, B1 being the lowest frequency band, Bi being at least one intermediate frequency band and BN the highest frequency band, comprises a side wall axisymmetric about a longitudinal axis Z, an axial access orifice, termed throat, and a radiating aperture, the side wall comprising annular corrugations. The horn antenna further comprises four coaxial probes diametrically opposite in pairs. The four probes are inserted into a specific, dedicated corrugation, the four coaxial probes being spaced apart at equal angles in a plane perpendicular to the longitudinal axis Z and entering the longitudinal axial conduit of the horn antenna. Each coaxial probe is designed for the propagation of signals in the lowest frequency band B1 of the spectrum.

### CROSS-REFERENCE TO RELATED APPLICATIONS

This application claims priority to foreign French patent application No. FR 1502126, filed on Oct. 9, 2015, the disclosure of which is incorporated by reference in its entirety.

### FIELD OF THE INVENTION

The present invention relates to a compact multi-frequency horn antenna, a radiating feed and an antenna comprising such a horn antenna. It relates to any type of antenna comprising a horn antenna illuminating a reflector in the context of space or ground-based antenna applications, both in the field of telecommunications and in the field of observation and earth sciences instruments, such as the field of altimetry and radiometry.

### BACKGROUND

Antennae, whether ground-based or mounted on satellites, are generally designed for a specific mission and are optimized for operation in one or more separate frequency bands, for example the two bands K and Ka or the two bands Ku and Ka. In order to carry out multiple different missions, for example telecommunications and altimetry missions, or for operation over a broader range of frequencies, for example in the four frequency bands C, Ku, K, Ka, it is then necessary to use multiple different antennae, designed for each frequency band and for each mission. Since each antenna is associated with a dedicated signal processing unit, installing the various antenna systems represents a bulky, heavy and costly payload which is difficult to reconcile with the space available on board the satellites and which involves a penalty in terms of total mass.

Thus, in the field of terrestrial observation, for example for measuring the topography of the Earth's surface, oceanographic phenomena, wind speeds and water vapour in the atmosphere, it is usual for multiple different altimetry and radiometry instruments to be installed on a satellite. These instruments are mutually independent, with each instrument comprising its own antenna associated with dedicated signal processing so as to permit a good degree of precision of the measurements in the various separate frequency bands. However, platforms designed for observation of the Earth are frequently mini- or micro-satellites having limited options for the installation of multiple missions. Furthermore, the use of multiple independent instruments does not make it possible to aim at a nadir that is common to all the instruments, which makes it necessary to provide corrections in order to ensure proper correlation of the altimetry and radiometry measurements, and introduces inaccuracies and errors which can be difficult to minimize or even impossible to eliminate.

There are antennae using a horn antenna illuminating a reflector, the horn being able to operate at multiple frequencies, but, since all the signals pass through the horn from its small throat diameter to its large radiating aperture diameter, the greater the frequency excursion, the more difficult it is to achieve a good level of performance over the entire operating frequency spectrum. Moreover, the lower the operating frequency, the larger the horn antenna, and it is therefore difficult to optimize the size of the horn over a spectrum of frequencies covering more than two octaves.

In particular, it is known from document U.S. Pat. No. 5,175,555 to create a combined altimetry and radiometry antenna that can operate in four different frequency bands, using a single horn antenna shared between an altimetry system and a radiometry system. The conical horn antenna is provided with four different ports respectively designed for four operating frequency bands. The three ports corresponding to the lowest frequencies are coupled to openings of rectangular cross section created in the diverging wall of the horn, between the throat and the larger-diameter radiating aperture of the horn. The port corresponding to the highest frequencies is arranged in the throat of the horn. The four ports are all located very close to the throat of the horn. This horn makes it possible to obtain a frequency excursion over a bandwidth between 13.5 GHz and 36.56 GHz, corresponding to the three bands Ku, K, Ka; however, it does not permit operation at frequencies below 13.5 GHz and in particular in the C band whose central frequency is equal to 6.6 GHz.

U.S. Pat. No. 4,258,366 describes an antenna comprising a conical horn antenna provided with correlations and fed simultaneously with multiple signals at different frequencies between 6 and 37 GHz. The lowest frequency at 6.6 GHz is fed into the horn by lateral ports consisting of a pair of longitudinal slots located close to the throat of the horn, that is to say at that end of the horn having the smallest diameter. The two diametrically opposite slots are fed by the intermediary of an adapter and a tee power divider. The frequencies above 6.6 GHz are fed by a waveguide of circular cross section connected to that end of the horn having the smallest diameter, termed the throat. The problem is that the diameter of the throat of the horn must be large enough, that is to say greater than or equal to 30 mm, to permit propagation of the frequencies in the C band. Equally, the length of the horn and the aperture diameter of the horn must be sufficient to permit propagation of the frequencies in the C band. Another problem is that the aperture diameter of the horn necessary for propagation of the signals in the lowest frequency band, for example the C band, involves a consequent penalty in terms of the overall space requirement of the horn, which makes this antenna solution too voluminous to be mounted on a mini-satellite or on a micro-satellite.

There is therefore a need to create a horn antenna that is compact, lightweight and low-cost, that operates in multiple different frequency bands, for example the four frequency bands C, Ku, K, Ka, that makes it possible to combine multiple different applications on a single antenna, and that thus makes it possible to selectively carry out various telecommunication missions in the various frequency bands, or to carry out all the altimetry and radiometry functions covering the various frequency bands.

In particular, there is a need to create a horn antenna that is more compact than the known horn antennas whose lowest operating frequency, for example in the C band, requires large dimensions.

### SUMMARY OF THE INVENTION

The aim of the invention is to create a multi-frequency horn antenna that does not have the drawbacks of the known horn antennas, operating over a very wide frequency spectrum covering multiple different frequency bands, such as for example the four frequency bands C, Ku, K, Ka, the horn antenna being more compact than the known horn antennas.

Another aim of the invention is to create an antenna comprising such a horn antenna.

To that end, the invention relates to a multi-frequency horn antenna able to propagate signals in a spectrum of frequencies comprising multiple different frequency bands B1, . . . , Bi, . . . ,BN, i being between 1 and N, B1 being the lowest frequency band, Bi being at least one intermediate frequency band and BN the highest frequency band, the horn antenna comprising a side wall axisymmetric about a longitudinal axis Z, an axial access orifice, termed throat, and a radiating aperture opposite the axial access orifice, the side wall bounding a longitudinal axial conduit connecting the axial access orifice and the radiating aperture, the longitudinal axial conduit having, in cross section, a diameter that increases between the axial access orifice and the radiating aperture, the side wall comprising an internal surface consisting of a plurality of concentric annular corrugations, located in successive planes that are mutually parallel and perpendicular to the longitudinal axis Z, each corrugation being centred on the longitudinal axis Z. The horn antenna further comprises four probes which are coaxial and diametrically opposite in pairs, inserted into a specific, dedicated corrugation of the side wall, perpendicular to the longitudinal axis Z, the four coaxial probes being spaced apart at equal angles in a plane perpendicular to the longitudinal axis Z and entering the longitudinal axial conduit of the horn antenna, each coaxial probe being designed for the propagation of signals in the lowest frequency band B1 of the frequency spectrum.

Advantageously, each coaxial probe may consist of a metal stem comprising one end secured to a metal end piece, the metal end piece being shaped as a disc or a frustum, the metal end piece being perpendicular to the metal stem, the metal end piece projecting into the longitudinal axial conduit of the horn antenna.

Advantageously, the horn antenna may further comprise four coaxial connectors respectively associated with the four coaxial probes, each coaxial connector comprising a metal core and a base attached to an outer surface of the side wall of the horn antenna, the metal stem of each coaxial probe respectively consisting of the metal core of the corresponding coaxial connector.

Advantageously, each coaxial connector may be connected to a coaxial filter designed for adapting the corresponding coaxial probe, in the lowest frequency band B1 of the frequency spectrum.

Advantageously, the horn antenna may comprise multiple sets of coaxial probes inserted into different specific corrugations having different internal diameters, each set of coaxial probes being designed for the propagation of signals in different frequency bands.

Advantageously, the lowest frequency band B1 may be the C band.

The invention also relates to a radiating feed comprising a horn antenna and further comprising an axial waveguide connected to the axial access orifice of the horn antenna, transverse ports coupled perpendicular to said axial waveguide and an axial terminal port, the transverse ports being respectively designed for propagating the intermediate frequency bands and the axial terminal port being able to propagate the highest frequency band of the frequency spectrum, the axial waveguide having a cross section that diminishes between the axial access orifice and the axial terminal port.

Advantageously, the source may comprise two transverse access ports respectively designed for two different intermediate frequency bands Ku and K.

Advantageously, the highest frequency band of the frequency spectrum may be the band Ka.

The invention also relates to an antenna comprising a horn antenna and at least one reflector, the horn antenna illuminating the reflector.

### BRIEF DESCRIPTION OF THE DRAWINGS

Other characteristics and advantages of the invention will appear clearly in the remainder of the description, which is provided by way of a purely illustrative and non-limiting example with reference to the appended diagrammatic drawings, in which:

FIGS. 1a and 1b show two diagrams, respectively in longitudinal section and in perspective, of an example of the internal structure of a horn antenna provided with corrugations and comprising coaxial probes, according to the invention;

FIGS. 2a and 2b show a partial diagram, in transverse section, showing the position of the four coaxial probes inside the horn antenna and, respectively, a diagram, as seen from above, of the position of the four coaxial probes in a specific corrugation of the horn antenna, according to the invention;

FIG. 3 shows a partial, perspective diagram of a corrugation fitted with four coaxial probes of which two are respectively connected in series to coaxial connectors associated with adaptation filters, according to the invention;

FIG. 4 shows a profile diagram of a horn antenna comprising a corrugation fitted with coaxial probes of which two are respectively connected in series to coaxial connectors associated with adaptation filters, according to the invention;

FIG. 5a shows a perspective diagram of an antenna radiofrequency feed comprising a horn antenna coupled to a multi-frequency exciter, according to the invention;

FIG. 5b shows a synoptic diagram, in longitudinal section, of an antenna radiofrequency feed comprising a horn antenna coupled to a multi-frequency exciter, according to the invention;

FIG. 6 shows a perspective diagram, of an example of an antenna comprising a horn antenna, according to the invention;

FIG. 7 shows a diagram, in longitudinal section, of an example of a horn antenna comprising multiple sets of coaxial probes designed for different frequency bands, according to the invention.

### DETAILED DESCRIPTION

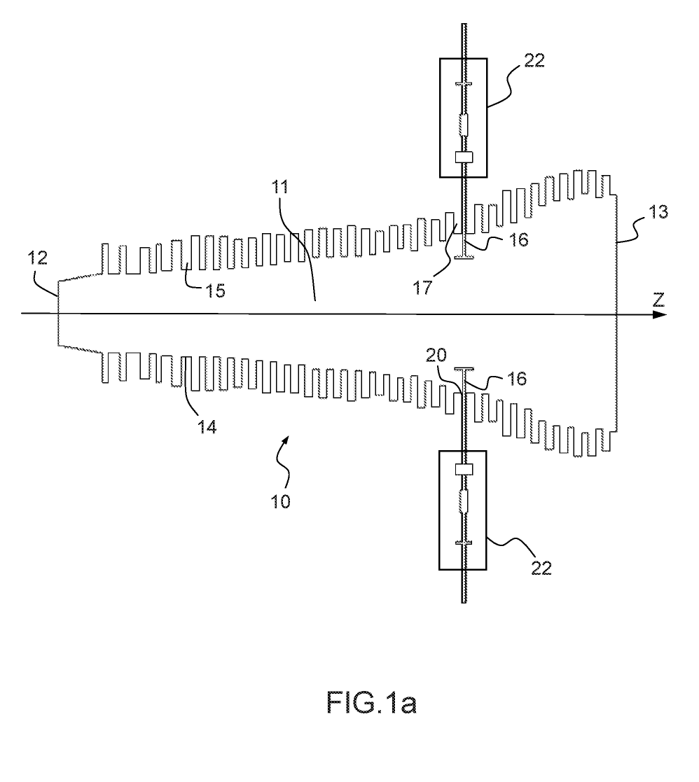

The invention relates to a multi-frequency horn antenna able to propagate signals in a spectrum of frequencies comprising multiple different frequency bands B1, . . . , Bi, . . . ,BN, i being between 1 and N, B1 being the lowest frequency band, Bi being at least one intermediate frequency band and BN the highest frequency band. As shown in FIGS. 1a and 1b, the horn antenna 10 comprises a side wall 14 extending longitudinally, along a longitudinal axis Z, an axial access orifice 12, also termed throat, and a radiating aperture 13 opposite the axial access orifice. The side wall 14 is axisymmetric about the longitudinal axis Z and bounds a longitudinal axial conduit 11 connecting the axial access orifice 12 and the radiating aperture 13, the longitudinal axial conduit 11 having, in cross section, a diameter that increases between the axial access orifice and the radiating aperture. The side wall 14 comprises an internal surface consisting of a plurality of concentric annular corrugations 15, located in successive planes that are mutually parallel and perpendicular to the longitudinal axis Z, each corrugation 15 being centred on the longitudinal axis Z.

The horn antenna 10 further comprises four coaxial probes 16, diametrically opposite in pairs, inserted perpendicular to the longitudinal axis Z, through four respective cylindrical orifices 20 machined into a specific corrugation 17 of the side wall 14, the four cylindrical orifices allowing the core of the coaxial probes to pass through. The four coaxial probes are respectively provided with coaxial adaptation filters 22 located outside the side wall 14 of the horn 10. The four coaxial probes 16 are spaced apart at equal angles in a plane perpendicular to the longitudinal axis Z and enter the longitudinal axial conduit 11 of the horn, each coaxial probe 16 being designed for the propagation of signals in the lowest of the frequency bands of the spectrum of operating frequencies of the horn antenna, such as for example in the C band, between 5.25 GHz and 5.6 GHz. The structure of the horn antenna 10 is therefore perfectly symmetric with respect to the longitudinal axis Z and the use of the four probes properly angularly spaced at 90° from one another, makes it possible to excite the fundamental mode of propagation and to minimize the impact of the undesired higher-order modes of propagation. Advantageously, in order that pick-up of the signals of the lowest frequency band B1, for example the C band, is favoured, the specific corrugation 17 is located closer to the radiating aperture 13 of the horn antenna than to the axial access orifice 12. The internal diameter of the specific corrugation 17 has a value chosen such that the propagation of the fundamental mode corresponding to the lowest frequency band B1 is possible.

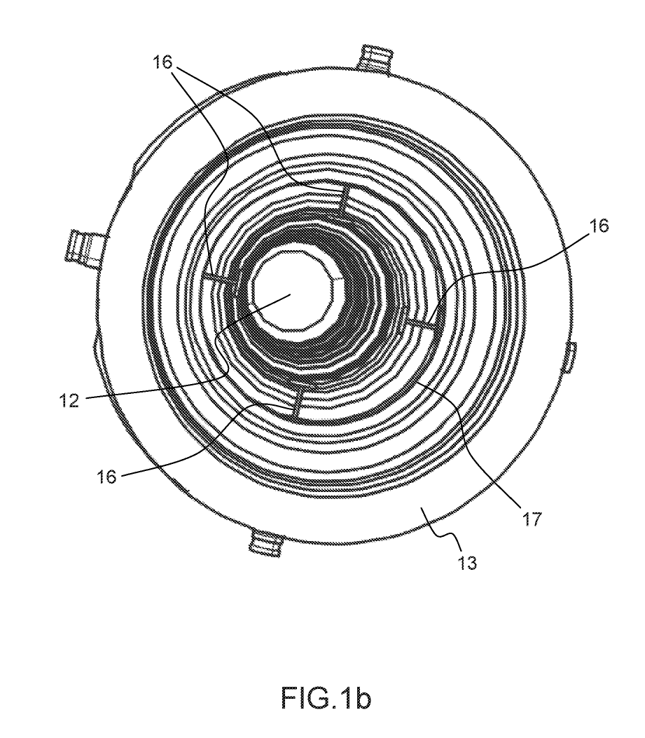

As shown in greater detail in FIGS. 2a and 2b, each coaxial probe 16 may consist of a metal stem 18 comprising one end secured to a metal end piece 19, the metal end piece 19 being preferably shaped as a disc or a frustum arranged perpendicular to the metal stem 18. The metal stem 18 passes through a cylindrical orifice, perpendicular to the longitudinal axis Z, created in the specific corrugation 17 of the side wall 14, and enters the longitudinal axial conduit 11 of the horn antenna 10. The four coaxial probes 16 are designed to feed signals in the lowest frequency band B1, into the horn antenna 10 in order that they propagate towards the radiating aperture 13, and conversely, to pick up signals in the lowest frequency band B1, originating from the radiating aperture 13 and entering the horn antenna 10. Contrary to the solutions of the prior art for which the low frequency band is picked up or fed close to the axial access orifice 12, according to the invention, the pick-up or feeding of the lowest frequency band, for example the C band, is effected at a distance from the axial access orifice through which the other, higher-frequency bands pass, and without passing through an intermediate closed cavity. In particular, the pick-up or feeding of the lowest frequency band B1 is effected close to the diameter of the radiating aperture 13 of the horn antenna. Given that the diameter of the radiating aperture of the horn antenna is much greater than the diameter of the axial access orifice, it is therefore not necessary to significantly increase the dimensions of the horn antenna in order to permit operation in the lowest frequency band B1, for example in the C band.

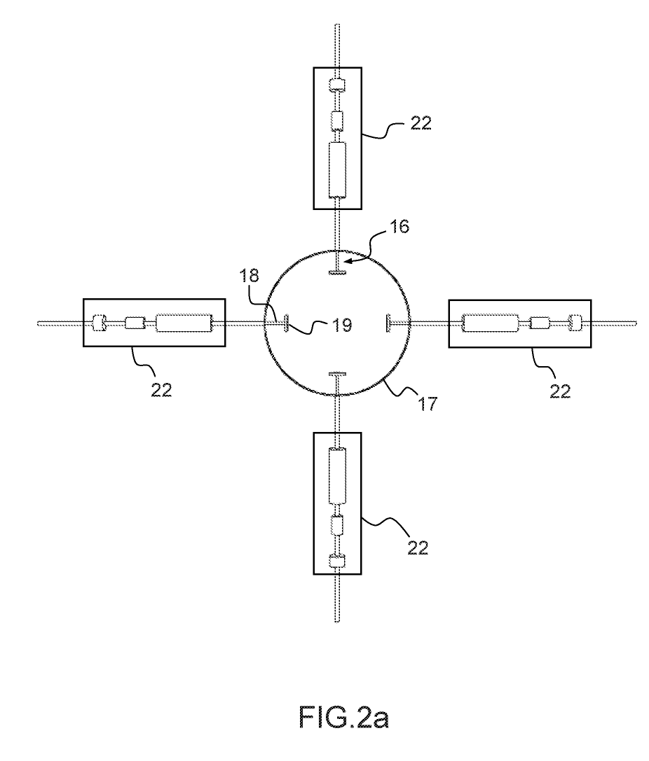

As shown in FIGS. 2b and 3, the horn antenna 10 may further comprise four coaxial connectors 21 respectively associated with the four coaxial probes 16, each coaxial connector 21 comprising an internal metal core that constitutes the metal stem 18 of a coaxial probe, a base 24 attached to an outer surface of the side wall of the horn antenna and an inlet/outlet access 25, secured to the base 24 and opening towards the outside of the horn antenna. The metal stem 18 of each coaxial probe 16 then respectively consists of the metal core of the corresponding coaxial connector 21, which is inserted inside the longitudinal axial conduit 11 of the horn antenna, through a cylindrical orifice created in the side wall 14 of the horn antenna and through the dedicated specific corrugation 17. The specific corrugation 17 is an annular crown having an internal diameter of which the value is compatible with the propagation of signals in the lowest frequency band B1. For example, when B1 corresponds to the C band, between 5.25 GHz and 5.6 GHz, the internal diameter of the annular crown must be between 37 and 40 mm. In order for the size of the horn antenna to be small, the annular crown may preferably be located close to the larger-diameter end of the horn antenna, that is to say close to the radiating aperture 13.

So as not to degrade the radiation of the horn antenna in the frequency bands above the band B1, the dimensions of the coaxial probes must be made as small as possible, while remaining suitable for the propagation of signals in the band B1. For example, for the C band, the diameter of the metal end piece 19 of the metal stem 18 of each coaxial probe 16 may be between 4 mm and 5 mm. Furthermore, the depth of penetration of each coaxial probe 16 into the longitudinal axial conduit 11 of the horn antenna is the result of a compromise: on one hand, the coaxial probe must enter to a sufficient depth to be able to pick up or feed signals in the band B1 with sufficient energy, and on the other hand, the penetration depth of each coaxial probe must not be too great, so as not to degrade the signals in the higher frequency bands. For example, in order to be compatible with the C band, the penetration depth of each coaxial probe may be between 5 mm and 7 mm.

As a consequence of the presence of the metal end piece 19 at the end of the stem 18 of each coaxial probe 16 and as a consequence of the small dimensions of the coaxial probes and of the horn antenna, the insertion of each coaxial probe through a specific corrugation 17 of the horn antenna and the correct positioning of the four coaxial probes in the longitudinal axial conduit 11 of the horn antenna, are difficult to effect if the horn antenna is in one piece. In order to equip the horn antenna with the four coaxial probes, according to the invention, the horn antenna 10 is made in three distinct sections which are axisymmetric about the longitudinal axis Z, the specific corrugation 17 through which the four coaxial probes are inserted being preferably produced in an independent annular crown. Furthermore, the coaxial probes 16 are preferably inserted into the specific corrugation 17 before installation of their metal end piece 19. After insertion of the metal stems 18, each metal end piece is then respectively attached, preferably by brazing or by adhesive bonding using a conductive adhesive, to the end of the stem of a coaxial probe. For reasons of mechanical integrity with respect to vibrations and thermal integrity with respect to high temperatures, the brazing is preferred. After production, the independent annular crown fitted with the four coaxial probes constitutes an intermediate section of the horn antenna which is inserted between two end sections respectively containing the smaller diameters of the horn antenna and the larger diameters of the horn antenna, the three sections—intermediate section and end sections—then being assembled with one another using any known type of connection, for example by welding, or brazing, or using nut-and-bolt connections.

The assembly consisting of a coaxial connector and a coaxial probe is able to excite the horn antenna in the band B1 and the inlet/outlet access 25 of each coaxial connector is an inlet/outlet access for the signals in the band B1, which are propagated by the respective coaxial probes. The type of polarization—vertical or horizontal linear, or right-handed or left-handed circular—is determined by the orientation of the horn antenna and by the use of couplers connected to the output of the coaxial filters, such as, for example, a 3 dB/90° coupler to create the right-handed and left-handed circular polarizations after summing the signals picked up in the longitudinal axial conduit 11 of the horn antenna, or after dividing the signals fed into the longitudinal axial conduit 11 of the horn antenna, the summed or divided signals originating from paired, diametrically opposite coaxial probes.

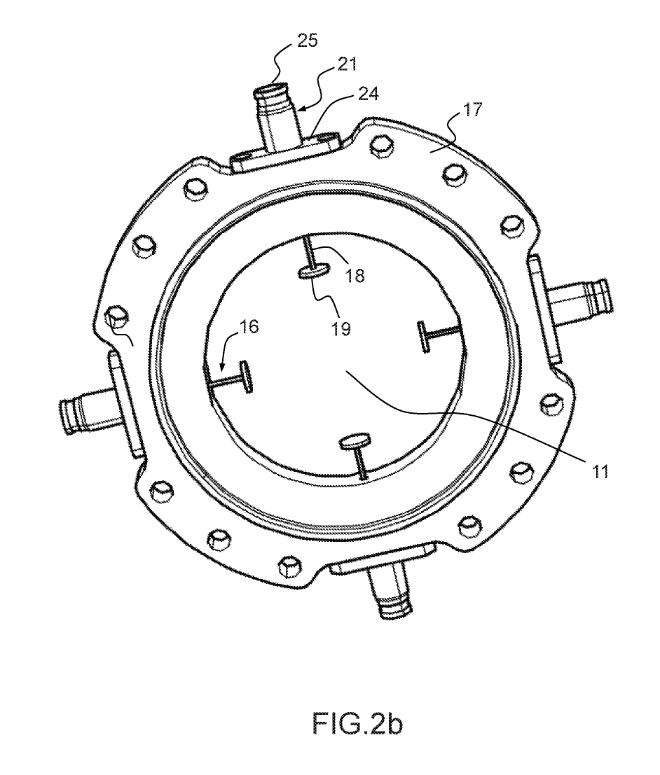

In order to optimize the propagation of signals in the frequency band B1 and to improve the performances of the coaxial probes, each coaxial probe 16 may, preferably, be connected in series with a coaxial filter 22 designed for adapting the corresponding coaxial probe to the frequency band B1. Each coaxial adaptation filter 22 is placed outside the side wall 14 of the horn antenna and is connected, directly by a coaxial elbow (not shown) or by a coaxial cable 23, to the corresponding coaxial connector 21, as shown for example in FIGS. 3 and 4. So as not to overcomplicate FIGS. 3 and 4, only two coaxial filters 22 are shown, but it is understood that each coaxial probe is equipped with a dedicated coaxial filter and there are therefore four coaxial filters respectively connected to the four coaxial probes.

Since the four coaxial probes are installed inside the longitudinal axial conduit 11 of the horn antenna via the intermediary of the specific corrugation 17, the signals in the frequency band B1 are directly fed, or picked up, inside the horn antenna, without passing through the axial access orifice 12 of the horn antenna. This makes it possible to reduce the size of the horn antenna, which corresponds to the size of a horn antenna operating in an intermediate frequency band Bi, immediately above the lowest frequency band B1 picked up or fed by the coaxial probes. When the band B1 is the C band, the bulkiness of the horn antenna is then 2.5 to 3 times less with respect to the bulkiness of a conventional horn antenna operating in the C band.

The diametrically opposed coaxial probes 16 can then be respectively connected in pairs, via the intermediary of the respective coaxial filters, by a dedicated coupler, not shown, each coupler comprising a port named “summing port” designed for the propagation of signals in the considered band B1. The summing port of each coupler makes it possible to propagate or recover the signal of one and the same horizontal or vertical linear polarization, depending on the orientation given to the horn antenna. The two linear polarizations borne respectively by the two couplers are mutually perpendicular. If one wished to propagate right-handed and left-handed circular polarizations, it would be further necessary to connect a 3 dB/90° coupler to the output of the two couplers summing the signals which are picked up, or dividing the signals which are fed, and connecting the coaxial probes in pairs, so as to combine in terms of phase the two horizontal and vertical linear polarizations and thus obtain two right-handed and left-handed circular polarizations.

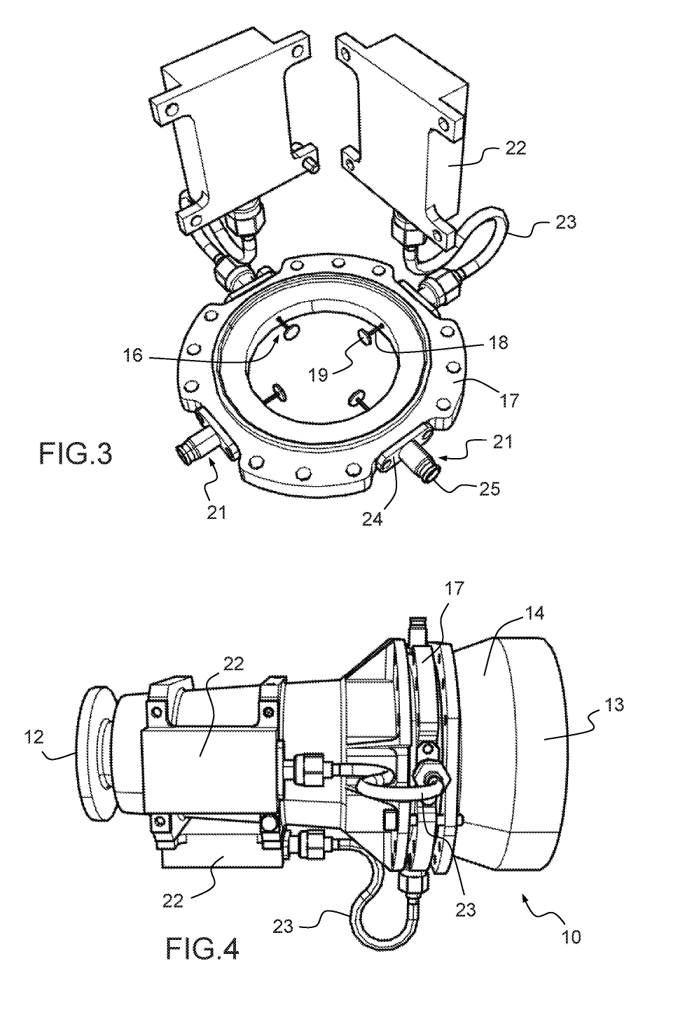

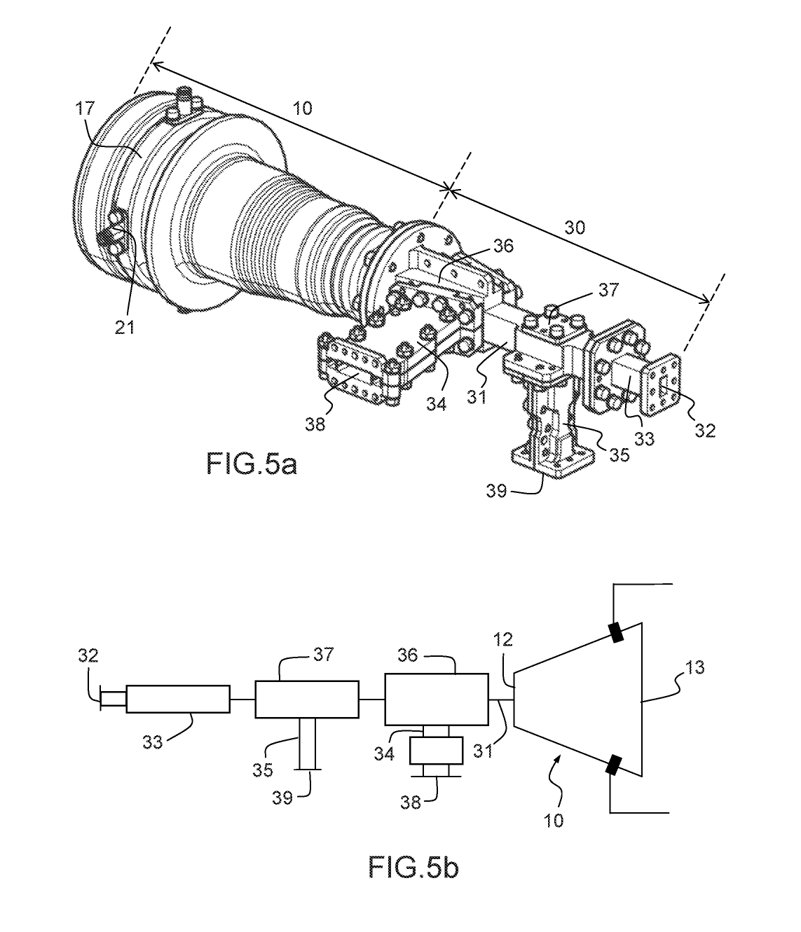

As shown in the example shown in FIGS. 5a and 5b, in order to permit operation of the horn antenna in frequency bands above the band B1, the horn antenna 10 is coupled to an excitation assembly, termed exciter 30. The assembly consisting of the horn antenna and the exciter constitutes a multi-frequency and multi-port radiofrequency feed. The exciter 30 comprises an axial waveguide 31 of circular cross section, termed common port of the exciter, which is directly connected to the axial access orifice 12, in line with the longitudinal axial conduit 11, an axial terminal port 32 coupled to the axial waveguide 31 via a dedicated transition 33, and transverse connections 34, 35 coupled to the axial waveguide 31 by means of orthomode transducers 36, 37, that are respectively designed for propagating the different intermediate frequency bands Bi which are not picked up in the side wall 14 of the horn antenna 10. The axial waveguide 31 comprises sections of decreasing dimensions between the axial access orifice 12 and the axial terminal port 32 which is able to propagate the highest frequency band, for example the band Ka between 31.3 GHz and 31.5 GHz. The number of transverse connections is equal to the number of desired intermediate frequency bands Bi. In the example shown in FIGS. 5a and 5b, the axial waveguide comprises two lateral connections 34, 35, including filters designed for adapting the respective operating frequency band, coupled perpendicular to said axial waveguide 31, and respectively provided with a transverse port 38, 39. The two transverse ports 38, 39 may for example be respectively designed for propagating the bands Ku between 13.4 GHz and 13.75 GHz and K between 23.7 GHz and 23.9 GHz. The various ports—the terminal port 32 and the transverse ports 38, 39—are conventional rectangular ports. Their respective orientation, associated with the orientation of the radiofrequency feed provided with a horn antenna 10 and a exciter 30 and mounted in an antenna 40, determines the type of linear polarization—horizontal or vertical—propagated through the horn antenna.

Each port, both transverse and terminal, which is coupled to the axial waveguide may be associated with a filter whose presence is optional but which helps to adapt said port to a respective frequency band, for example Ku, K, or Ka. Of course, it is possible to choose operating frequency bands other than those explicitly described, and to add additional ports as required.

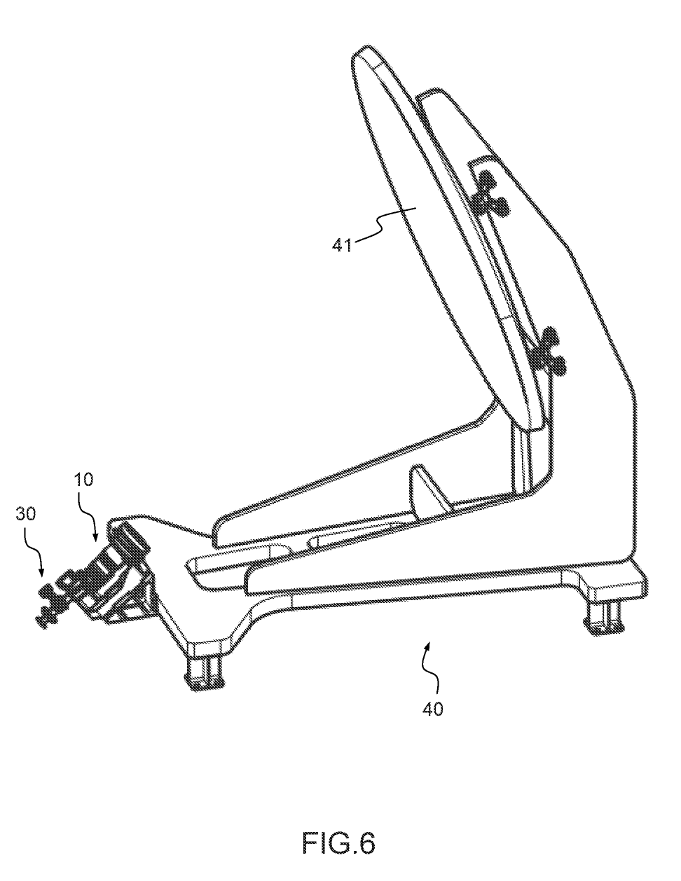

The multi-frequency horn antenna equipped with the four coaxial probes in accordance with the invention, and with a exciter as described above, is particularly compact and may be used as the primary feed in any type of antenna comprising at least one reflector as shown for example in FIG. 6. An antenna 40 comprising a reflector 41 illuminated by the radiofrequency feed provided with a horn antenna 10 and a exciter 30 in accordance with the invention, may for example be used in a multi-frequency telecommunications system or in a multi-frequency altimetry and radiometry application.

The multi-frequency horn antenna of the invention has the advantage of combining the functionalities of at least four different instruments in the same antenna and illuminating the antenna reflector by means of a single horn antenna and thus with an identical aperture, common to all the instruments, the various beams produced by the antenna having ground footprints that are superposed and overlap entirely or in part. This makes it possible to perform very precise altimetry and radiometry measurements since the terrestrial reliefs illuminated by the antenna are partially or entirely identical for all of the instruments. This also makes it possible, on one hand, to maximize the performance of the antenna without it being necessary to increase the diameter of the antenna reflector since a single horn antenna is placed exactly at the focal point of the antenna and, on the other hand, to benefit from a small variation in the phase centre of the horn antenna, close to the focal point of the antenna, depending on the considered frequency band, in contrast to the case in which multiple horns are used.

By way of example, an antenna provided with a reflector and with the horn antenna associated with a exciter operating in the four frequency bands C, Ku, K, Ka has been created. In operation, the estimated centres of the footprints of the beams beamed onto the Earth by the antenna, in the four frequency bands C, Ku, K and Ka, were aligned to within 0.05° of one another.

In the examples explicitly described above, the coaxial probes 16 are mounted in a single specific corrugation 17 of the horn antenna, the specific corrugation 17 being an annular crown having an internal diameter compatible with the lowest frequency band B1 of the spectrum and are designed for feeding and extraction of signals only in the lowest frequency band. However, more generally, it is of course also possible to extract multiple different frequency bands via the intermediary of dedicated coaxial probes mounted in different specific annular corrugations 17a, 17b, 17c of the horn antenna, the different specific corrugations 17a, 17b, 17c having different internal diameters of which the respective values depend directly on the central frequencies of the respective desired operating bands. The values of the internal diameter of the specific corrugations in the different frequency bands are estimated, as a first approximation, by calculating the homothety of the desired range of frequencies with respect to the range of frequencies of the C band. For the X band, in which the range of frequencies can be centred, for example, around 8 GHz, the homothetic coefficient of reduction of the dimensions known for the C band is between 0.65 (5.25 GHz/8 GHz) and 0.7 (5.6 GHz/8 GHz) to obtain the value of the diameter corresponding to the band X, the diameter then being between 24 mm (0.65×37 mm) and 28 mm (0.7×40 mm).

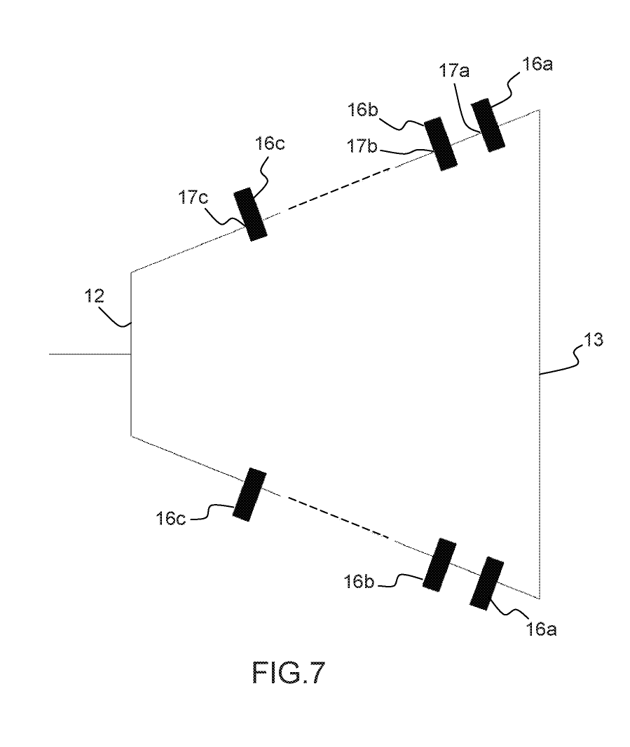

FIG. 7 shows a diagram in longitudinal section of an exemplary embodiment in which three frequency bands C, Ku and Ka are picked up through the side wall of the horn antenna via the intermediary of three different sets of coaxial probes, 16a, 16b, 16c arranged in three different specific corrugations of the horn antenna. The three specific corrugations have different internal diameters suitable for propagation of the signals in the respective frequency bands. The lower the frequency band, the larger the internal diameters of the different specific corrugations and the closer these are to the diameter of the radiating aperture 13 of the horn antenna. Therefore, in FIG. 7, the signals in the C band are extracted and fed by first coaxial probes 16a installed in a specific corrugation of larger internal diameter, located closest to the radiating aperture 13 of the horn antenna. Second coaxial probes 16b designed for signals in the intermediate band Ku, are installed in a specific corrugation of intermediate diameter and third coaxial probes 16c designed for the band Ka are located in a specific corrugation of smaller internal diameter located further from the diameter of the radiating aperture 13. Each set of coaxial probes may comprise four coaxial probes at a regular angular spacing, the coaxial probes being diametrically opposite in pairs. In FIG. 7, two opposite coaxial probes are visible for each operating frequency band, the two diametrically opposed coaxial probes making it possible to excite the horn antenna according to either the vertical or horizontal linear polarization.

Although the invention has been described in connection with particular embodiments, it is obvious that the invention is in no way limited thereto and that it encompasses all of the technical equivalents of the means described as well as combinations thereof insofar as they fall within the scope of the invention. In particular, the frequency bands explicitly described are merely exemplary embodiments and may of course be replaced by any other desired frequency bands. In particular, the lowest frequency band may be a frequency band other than the C band and the intermediate- and high-frequency bands may also be other than the frequency bands Ku, K, Ka explicitly described. Furthermore, the number of specific corrugations equipped with coaxial probes is not limited to one. The horn antenna may comprise N specific corrugations equipped with coaxial probes, where N is greater than or equal to one. The number N of specific corrugations and their internal diameter depends on the frequency bands to be propagated by coaxial probes installed in said specific corrugations.

1. A multi-frequency horn antenna able to propagate signals in a spectrum of frequencies comprising multiple different frequency bands B1, . . . , Bi, . . . ,BN, i being between 1 and N, B1 being the lowest frequency band, Bi being at least one intermediate frequency band and BN the highest frequency band, the horn antenna comprising a side wall axisymmetric about a longitudinal axis Z, an axial access orifice, termed throat, and a radiating aperture opposite the axial access orifice, the side wall bounding a longitudinal axial conduit connecting the axial access orifice and the radiating aperture, the longitudinal axial conduit having, in cross section, a diameter that increases between the axial access orifice and the radiating aperture, the side wall comprising an internal surface consisting of a plurality of concentric annular corrugations located in successive planes that are mutually parallel and perpendicular to the longitudinal axis Z, each corrugation being centred on the longitudinal axis Z, the horn antenna further comprising four coaxial probes which are diametrically opposite in pairs, inserted into a specific, dedicated corrugation of the side wall, perpendicular to the longitudinal axis Z, the four coaxial probes being spaced apart at equal angles in a plane perpendicular to the longitudinal axis Z and entering the longitudinal axial conduit of the horn antenna, each coaxial probe being designed for the propagation of signals in the lowest frequency band B1 of the frequency spectrum.

2. The horn antenna according to claim 1, wherein each coaxial probe consists of a metal stem comprising one end secured to a metal end piece, the metal end piece being shaped as a disc or a frustum, the metal end piece being perpendicular to the metal stem, the metal end piece projecting into the longitudinal axial conduit of the horn antenna.

3. The horn antenna according to claim 2, further comprising four coaxial connectors respectively associated with the four coaxial probes, each coaxial connector comprising a metal core and a base attached to an outer surface of the side wall of the horn antenna, the metal stem of each coaxial probe respectively consisting of the metal core of the corresponding coaxial connector.

4. The horn antenna according to claim 3, wherein each coaxial connector is connected to a coaxial filter designed for adapting the corresponding coaxial probe, in the lowest frequency band B1 of the frequency spectrum.

5. The horn antenna according to claim 1, comprising multiple sets of coaxial probes inserted into different specific corrugations having different internal diameters, each set of coaxial probes being designed for the propagation of signals in different frequency bands.

6. The horn antenna according to claim 1, wherein the lowest frequency band B1 is the C band.

7. A radiating feed comprising a horn antenna according to claim 1 and further comprising an axial waveguide connected to the axial access orifice of the horn antenna, transverse ports coupled perpendicular to said axial waveguide and an axial terminal port, the transverse ports being respectively designed for propagating the intermediate frequency bands and the axial terminal port being able to propagate the highest frequency band of the frequency spectrum, the axial waveguide having a cross section that diminishes between the axial access orifice and the axial terminal port.

8. The radiating feed according to claim 7, further comprising two transverse access ports respectively designed for two different intermediate frequency bands Ku and K.

9. The radiating feed according to claim 7, wherein the highest frequency band of the frequency spectrum is the Ka band.

10. An antenna comprising a horn antenna according to claim 1 and further comprising at least one reflector, the horn antenna illuminating the reflector.
